(19) United States
(12) Patent Application Publication
(10) Pub. No.: US 2003/0159321 A1
(43) Pub. Date: Aug. 28, 2003

(54) Signage system

(76) Inventor: Mervyn E. Dobbins, Alexander Heights (AU)

Correspondence Address: MERCHANT & GOULD PC, P.O. BOX 2903, MINNEAPOLIS, MN, 55402-0903, US

(21) Appl. No.: 10/297,150

(22) PCT Filed: May 29, 2001
(86) PCT No.: PCT/AU01/00633

(30) Foreign Application Priority Data
May 29, 2000 (AU) PQ 7823

(51) Int. Cl. G09F 7/00

(52) U.S. Cl. 40/607.05; 40/607.04; 40/601

(57) ABSTRACT

A signage system (10) for displaying a visual image. The signage system (10) comprises a support structure (11) such as a pole for installation at a display site. The support structure (11) is adapted to support display means (40) for presenting the visual image. The visual image displayed by the display means (40) is selectively changeable. The support structure (11) may also support a plurality of devices selected from a group comprising: signage; lighting apparatus; surveillance apparatus; communications apparatus; monitoring apparatus; and signalling apparatus.

### FIELD OF THE INVENTION

This invention relates to a signage system.

The invention has been devised particularly, although not necessarily solely, as a signage system for displaying a visual image in an outdoor environment. The visual image may be for any purpose, including but without limited to an image featuring material for information, decoration, ornamentation, advertisement, warning and general notices. The visual image may comprise text material, graphic images, graphic designs or any combination thereof.

### BACKGROUND ART

Signage currently in use for conveying information, advertisement, warning or the like may take various forms.

A well-known signage system involves a display face onto which posters, bills and similar such signs can be affixed. Typically, such display faces are in the form of signage boards and billboards. Although such a signage system is in very common use, it does have particular disadvantages. One disadvantage is that the sign is bonded onto the display face and so removal can be a rather messy and time-consuming procedure. With a view to avoiding difficulties associated with removal of such signs, it is often the case that fresh signs are simply installed over existing signs on the display face. This, however, only leads to an accumulation of layers of material which ultimately needs to be removed, further exacerbating difficulties associated with the removal process.

The posters and similar such signs are usually made of paper or vinyl. Generally, paper signs have limitations making them somewhat unsuitable for use as signage in an outdoor environment, so necessitating use of vinyl, which is more costly. Both paper and vinyl signs have the deficiency that the removal process involves destruction of the sign when replaced with a new sign even though it is possible that the replaced sign might still be commercially relevant.

A further difficulty with such existing signage relates to the need for complicated lighting systems to ensure that they are adequately illuminated at night time.

With a view to overcoming at least some of the above mentioned difficulties, various signage systems with the facility to accommodate replacement signs have been developed. Such signage systems typically comprise a display structure which accommodates replaceable panels which carry the signs. Typically, the display structures are securely affixed such as by fasteners onto a support structure (such as a pole) so making it difficult to readily change the sign being displayed. Indeed, it is often the case that scaffolding or cherry pickers are needed in order to obtain access to such display structures.

Signage which incorporates spools or rolls allows signs to be changed regularly. Images are carried on a conveyor belt which can be operated to move different images into a display position as required. In many cases, the conveyor belt incorporates a backlighting system which facilitates illumination of the sign. While such systems do allow variation in the signs being displayed, they can be costly to install and maintain. Furthermore, replacement of the spool which carries the images may require some skill in order to ensure that the signage system operates as intended.

In recent times there has been a trend towards electronic signage systems. While such systems allow images to be changed easily and in a non-destructive manner, they can be complex in construction, and relatively costly to install and maintain. Furthermore, the images produced by such electronic signage systems can be less effective in terms of their presentation than images carried on paper or vinyl signs.

Regardless of the type of signage system employed, the location at which the signage system is installed is of significant importance. Because many signage systems involve mounting on building structures or dedicated support structures such as poles, the location at which the sign can be installed is often less than desirable.

Furthermore, signage is generally excluded from locations where street signs, light poles and traffic signals are sited. Such locations are, however, generally prime locations insofar as visibility to passing traffic is concerned.

It is against this background, and that the problems and deficiencies associated therewith, that the present invention has been developed.

### DISCLOSURE OF THE INVENTION

The present invention provides a signage system for displaying a visual image, the signage system comprising a support structure for installation at a display site, the support structure being adapted to support display means for presenting the visual image, and mounting means for mounting the display means onto the support structure, wherein the visual image displayed by the display means is selectively changeable.

Preferably, the support structure may comprise a pole structure. The pole structure may be adapted to be removably accommodated in a receiving structure embedded in the ground at the display site. This arrangement permits the pole structure at the display site to be conveniently replaced with a similar such pole if desired.

The pole structure may be formed in at least two sections comprising a lower section and an upper section. The lower section may be adapted to be received in the receiving structure.

The upper section of the pole structure may be selectively removable from the lower section. This feature allows the upper section to be selectively removed from the lower section to facilitate its interchange with a replacement pole section or to facilitate replacement of any devices mounted thereon.

In one arrangement, the display means may comprise a first portion attached to the pole structure and a second portion adapted to be detachably connected to the first portion, the second portion being adapted to present the visual image. With this arrangement, when it is desired to vary the visual image, all that is necessary is to detach the second portion for the first portion and either change the visual image carried in the second portion or install a replacement second portion incorporating a new visual image.

The arrangement where the second portion is detachably connected to the first portion is particularly useful in circumstances where cabling is required for the display means. For instance, cabling may be necessary where electrical power is required for any purpose, such as illumination of the image or operation of an electronic circuit for generating the visual image. In such circumstances, the path defined by the cabling may incorporate a connector comprising a first part associated with the first portion and a second part associated with a second portion, whereby the first and second parts of the electrical connector are operatively connected one to another to complete the path when the second portion of the display means is moved into engagement with the first portion. Similarly, the first and second parts of the connector can separate when the second portion of the display means if moved out of engagement with the first portion.

The second portion of the display means may be adapted to be mounted onto a track system provided on the pole structure, whereby the second portion is moveable along the track system for movement into and out of engagement with the first portion. The track system may comprise one or more tracks formed integrally with the pole structure.

In another arrangement, the display means may comprise a display unit (such as a pod) selectively movable along the pole structure between operative and lowered positions, and a retaining means for releasably retaining the display unit in the operative position.

The pole structure may be provided with a track system along which the display unit can travel when moving between the operative and lowered positions.

A winch system may be provided for selectively moving the second portion of the display means or the display unit (as the case may be) along the pole structure. The winch system may have at least a portion thereof accommodated within the interior of the pole structure. The winch system may, for example, include a cable and pulley mechanism, with a length of the cable accommodated in the interior of the pole structure.

In addition to supporting the display means, the support structure may be adapted to support various other devices, including, but not limited to: lighting apparatus for illuminating the surrounding area; surveillance apparatus such as cameras; communications apparatus such as public address devices such as loud speakers, transmitting devices, and receiving devices; monitoring apparatus including devices for monitoring traffic movement; signalling apparatus including traffic signals; and signage such as signs depicting street names.

Where the pole structure is formed at least two sections, the display means is preferably mounted on the lower section.

Where devices mounted on the pole structure require cabling for their operation, such cabling may pass through the pole structure. The cabling can take any suitable form such as electrical cabling, telecommunications cabling, data cabling and fibre-optic cabling. Where such devices are selectively detachable from the pole structure, detachable connectors may be used to operatively connect the devices to the relevant cabling.

The cabling may extend down the pole structure to a terminal point to which it is connected to primary cabling installed underground.

Where the devices are computer controlled, a control system may be associated with the signage system. In one arrangement, the control system may be installed in the ground at the display site. In such an arrangement, the control system may be incorporated in a housing associated with the receiving structure. In another arrangement, the control system may be installed in the display means. Other arrangements are also possible.

Where the display means utilises a display panel such as a poster, the display means may incorporate a display frame for accommodating the display panel. The display frame may incorporate a peripheral frame structure having a portion thereof removable to allow installation and removal of the display panel.

The invention also provides a signage system comprising a pole structure and a plurality of devices supported on the pole structure, said devices being selected from a group comprising: signage; lighting apparatus; surveillance apparatus; communications apparatus; monitoring apparatus; and signalling apparatus.

The devices supported on the pole structure are selected according to the particular application of the signage system.

Typically, signage would be one of the devices supported on the pole structure. However, in certain applications there may not be a need for signage and the pole structure may support devices other than signage.

### BRIEF DESCRIPTION OF THE DRAWINGS

The invention will be better understood by reference to the following description of several specific embodiments thereof as shown in the accompanying drawings in which:

FIG. 1 is a schematic elevational view of a signing system according to a first embodiment;

FIG. 2 is a fragmentary view of the signage system showing a display means connected to a pole structure;

FIG. 3 is a perspective view of an upper end section of the display system shown in FIG. 1;

FIG. 4 is a schematic view of a signage system according to a second embodiment;

FIG. 5 is a schematic view of the signage system shown in FIG. 4 illustrating a display poster mounted thereon;

FIG. 6 is a schematic elevational view of a signage system according to a third embodiment;

FIG. 7 is a sectional view along line 7-7 of FIG. 6;

FIG. 8 is a fragmentary sectional view of the signage system according to the third embodiment, with the display means illustrated in an operative position; and

FIG. 9 is a view similar to FIG. 8 with the exception that the display means are shown in a lowered position.

### BEST MODE(S) FOR CARRYING OUT THE INVENTION

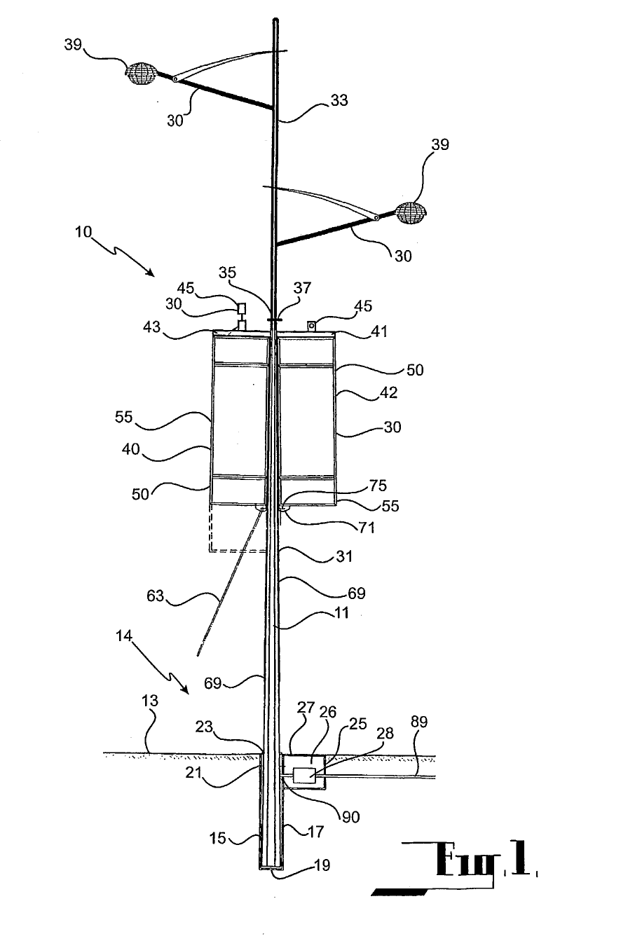

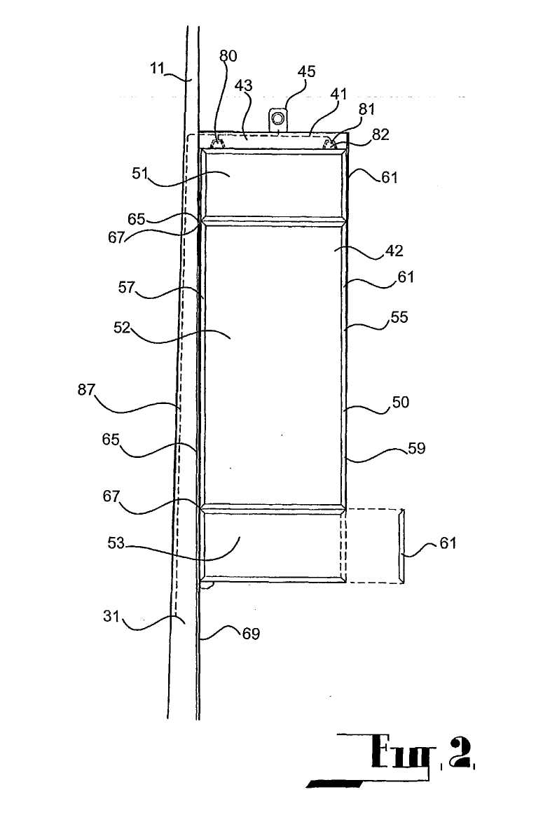

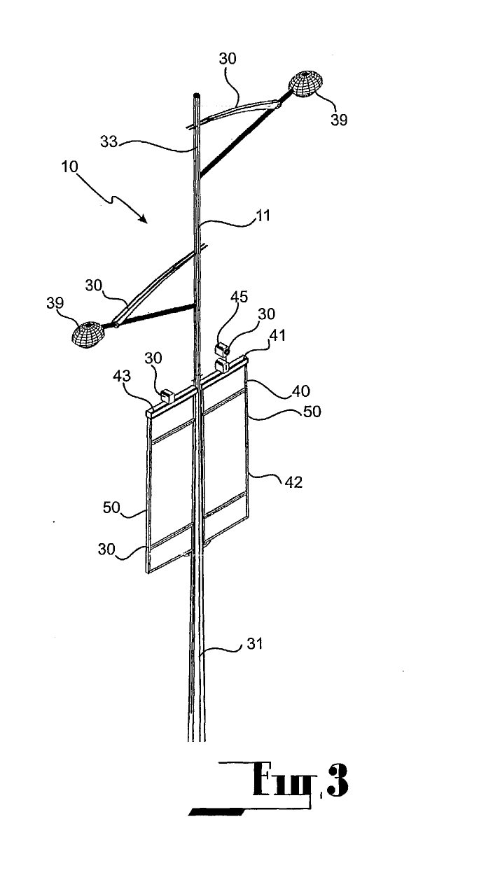

The first embodiment, which is shown in FIGS. 1, 2 and 3 of the drawings, is directed to a signage system 10 for installation in an outside environment, particularly on a road verge or in the median strip of a dual carriage road where it can also be used to provide street lighting.

The signage system 10 comprises a pole structure 11 mounted in the ground 13 at a display site 14. More particularly, the pole structure 11 is received and supported in a receiving structure 15 embedded in the ground at the display site. The receiving structure 15 incorporates a sleeve 17 having a base 19 at the lower end thereof, the bottom end of the pole structure 11 being received in the sleeve 17 with the bottom of the pole resting on the base 19.

A retaining means 21 in the form of a locking pin is provided for releasably retaining the pole structure 11 within the receiving structure 15. A surround 23 is provided around the pole structure 11 for closing the upper end of the receiving station 15 when the pole structure is accommodated therein. The surround 23 is in the form of a clamp plate.

A housing 25 defining compartment 26 is installed in the ground 13 adjacent the receiving station 15. In this embodiment, the housing 25 is formed integrally with the receiving station 15, as best seen in FIG. 1 of the drawings. The housing 25 incorporates a hatch 27 at ground level to provide access to the compartment.

The compartment 26 is adapted to accommodate control equipment 28 such as a computer system for controlling operation or processes performed by devices 30 mounted on the support structure as will be explained in detail later.

The pole structure 11 is formed in two sections, comprising a lower pole section 31 and an upper pole section 33. The two pole sections 31, 33 are releasably connected together at 35 by way of a removable locking pin 37. With this arrangement, the upper pole section 33 can be removed from the display site 14 without requiring removal of the lower pole section 31. The upper pole section may be removed from the lower section for various reasons, including interchange with an upper pole section of different configuration, or to facilitate attachment or removal devices 30 to the upper pole section. In the present embodiment, the upper pole section 33 carries devices 30 in the form of street lighting assemblies 39. It may also be that it is desired to replace the upper pole section 33 with a further pole section without street lighting assemblies or with street lighting assemblies of a different style. The interchangeable nature of the upper pole section 33 facilitates such changes.

One of the devices 30 carried by the pole structure 11 is a display means 40. The display means 40 comprises a first portion 41 and a second portion 42. The first portion 41 is in the form of a cross member 43 which is rigidly mounted onto the upper end of the lower pole section 31. The cross member 43 supports additional devices 30 which in this embodiment are in the form of security cameras 45.

The second portion 42 comprises two display structures 50 disposed on opposed sides of the pole structure. Each display structure 50 is in the form of a pod having three display zones, being an upper display zone 51, an intermediate display zone 52 and a lower display zone 53. Each display zone 51, 52 and 53 is adapted to hold a poster or similar sign for display purposes. Each display structure 50 incorporates a peripheral frame 55 having an inner edge 57 adapted to be mounted onto the pole structure 11 in a manner to be described, and an outer edge 59.

The peripheral frame 55 incorporates detachable frame sections 61 along the outer edge 59 to provide access to the display zones 51, 52 and 53 to permit installation and removal of display posters accommodated therein.

Each display structure 50 is mounted on the pole structure 11 for movement between an operative position in which it is in operative engagement with the adjacent side of the cross-member 43 (as illustrated in FIGS. 1, 2 and 3 of the drawings) and a second position in which it is out of engagement with the cross-member. Each display structure 50 is movable downwardly on the pole structure 11 out of engagement with the cross-member 43 into the second position where it is more accessible for installation or removal of the posters accommodated therein or exchange with an alternative display structure. Desirably, the display structure 50 is lowered to a second position in which it is easily accessible to a person standing on the ground 13. The display structure 50 may be moved between the operative and lowered second positions by any suitable means such as manually by engaging the display structure with a handling pole 63 (as shown in FIG. 1).

Each display structure 50 is moveable between the operative and lowered positions along a track structure 65. The track structure 65 comprises carriage members 67 provided on the inner edge 57 of the frame 55, and a track 69 provided on the pole structure 11. The carriage members 67 are slidably engaged with the track 69 for movement therealong.

A locking means 71 is provided for releasably securing each display structure 50 in its operative position. The locking means 71 incorporates a locking pin (not shown) movable between locking and release conditions. The locking pin is moveable into the release condition upon operation of a release trigger 75 which can be operated with the pole 63.

The first and second portion 41, 42 of the display means 30 incorporate connectors 80 for establishing an electrical, telecommunications or like path between the first and second portions of the display means 40. The connectors 80 comprise female members 81 incorporated in the cross-member 43 and corresponding male members 82 incorporated in the display structures 50. Mating female and male members 81, 82 are adapted to engage and release as the respective display structures 50 move into and out of engagement with the cross-member 43. In this way, corresponding female and male members 81, 82 co-operate to provide plug-in connectors. The connectors 80 are connected to cabling 87 extending along the interior of the pole structure 11.

Plug-in connectors of a similar style to the connectors 80 can be used to operatively connect other devices 30 supported on the pole structure 11 in cases where electrical, telecommunication or other paths are required. Specifically, such connectors can be used to connect the security cameras 45 to the cross member 43 and the lighting assemblies 39 to the upper pole section 33.

Cabling 87 accommodated in the interior of the pole structure 11 extends to the region of the pole structure 11 accommodated in the receiving structure 15 and is detachably connected to primary cabling 89 installed underground by way of a plug in connector at 90.

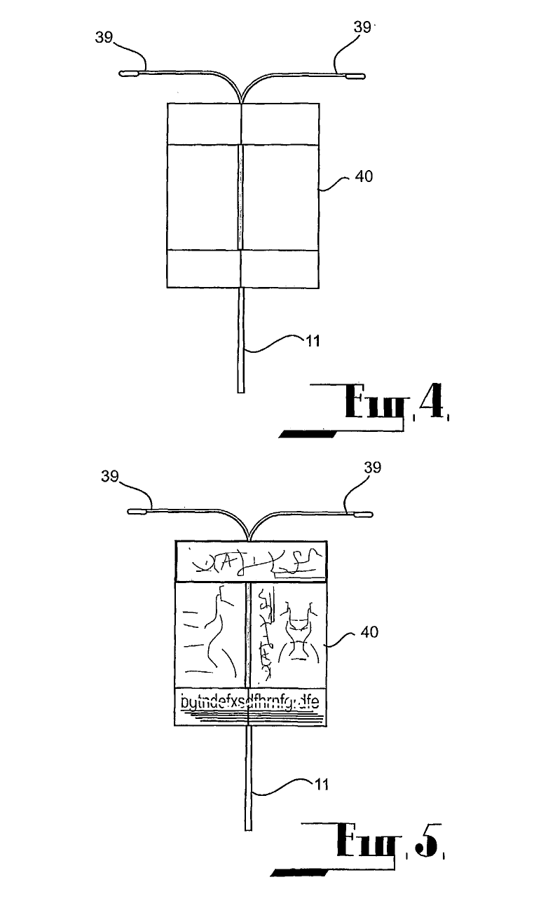

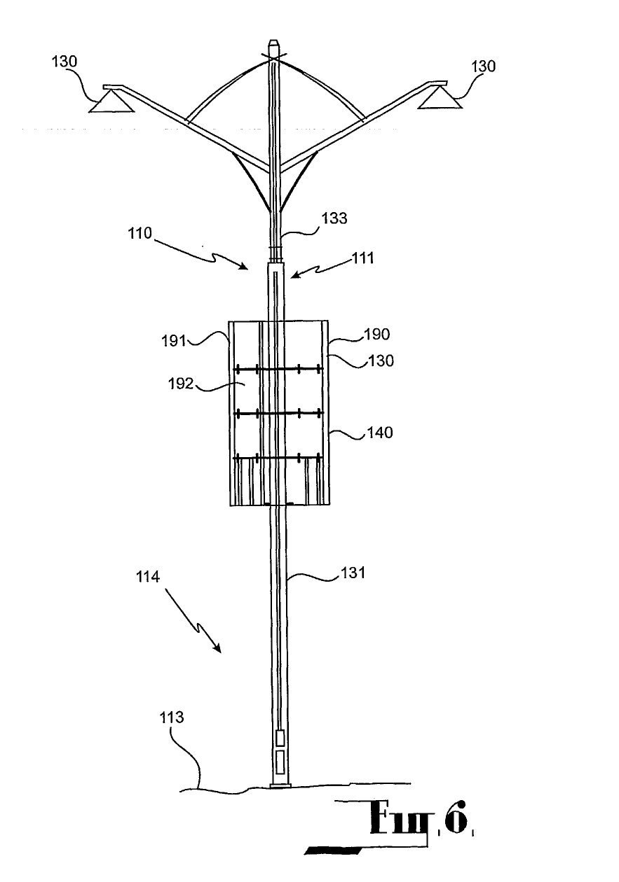

A second embodiment of the signage system is shown in FIGS. 4 and 5 of the drawings. In this embodiment, the lighting assemblies 39 are of a different configuration to the lighting assemblies 39 employed in the first embodiment. FIG. 5 of the drawings illustrates a pictorial sign displayed by the display means 40 supported on the pole structure 11.

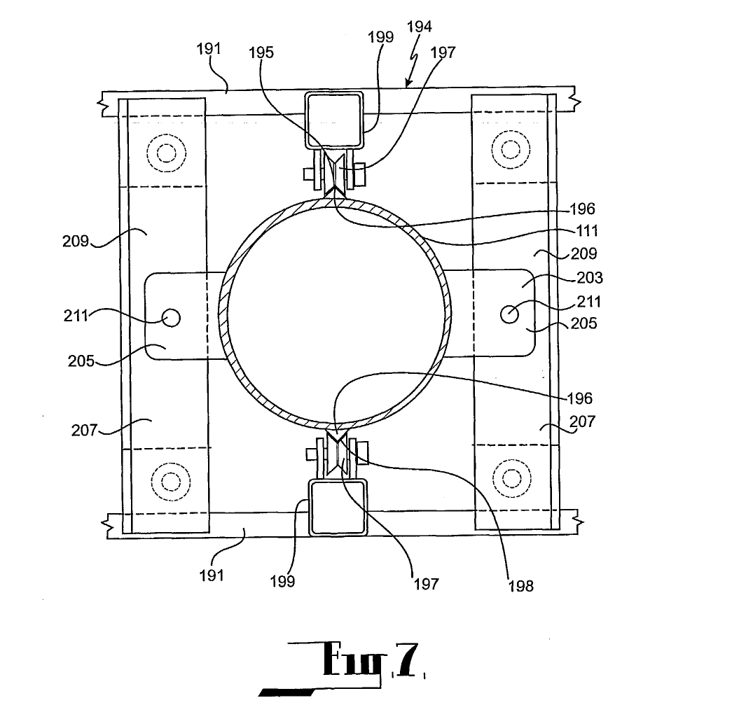

A third embodiment of the signage system is shown in FIGS. 6 to 9 of the drawings. The signage system 110 according to the third embodiment comprises a pole structure 111 mounted in the ground 113 at a display site 114.

The pole structure is formed in two sections, comprising a lower pole section 131 and an upper pole section 133, as was the case with the earlier embodiments. The two pole sections 131, 133 are releasably connected together in any suitable fashion such as by way of a removable locking pin (not shown). The pole structure 111 is adapted to support a plurality of devices 130 such as, for example, lighting apparatus, surveillance apparatus, communications apparatus, monitoring apparatus, and signalling apparatus. The particular devices 130 supported on the pole structure 111 are selected according to the particular application of the signage system.

One of the devices 130 carried by the pole structure 111 in this embodiment comprises a display means 140. The display means 140 comprises two display structures 190, each comprising a frame 191 surrounding a display area 192. The display area 192 is adapted to present a visual image in any appropriate way. The display area 192 may, for example, receive a poster which provides the visual image or it may comprise a screen adapted to display a visual image. Where posters and like signs are displayed, the display area 192 may incorporate a back-lighting system such an electroluminescent lamp.

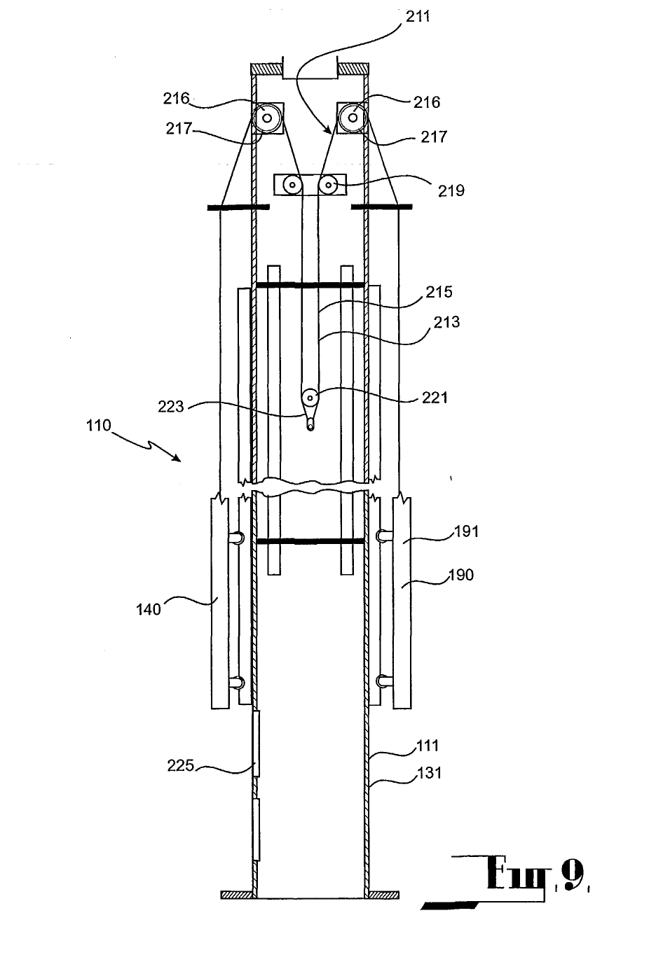

The display means 140 is mounted for movement when an operative position (as shown in FIG. 8) in which the display structures 190 supported in an elevated condition on the pole structure 111 so as to be readily visible, and a lowered position (as shown in FIG. 9) in which the display structures 190 readily accessible from the ground 113 for any necessary purpose such as maintenance or replacement of a poster on the like displayed therein.

The display means 140 is moveable along the pole structure 113 between the operative and lowered positions. For such purpose, the display means 140 incorporates a carriage 194 adapted to travel along a track 195 provided on the pole structure 111. The track 195 comprises two rails 196 provided on opposed sides of the pole structure. In this embodiment, each rail 196 comprises an extruded metal section of angular cross section.

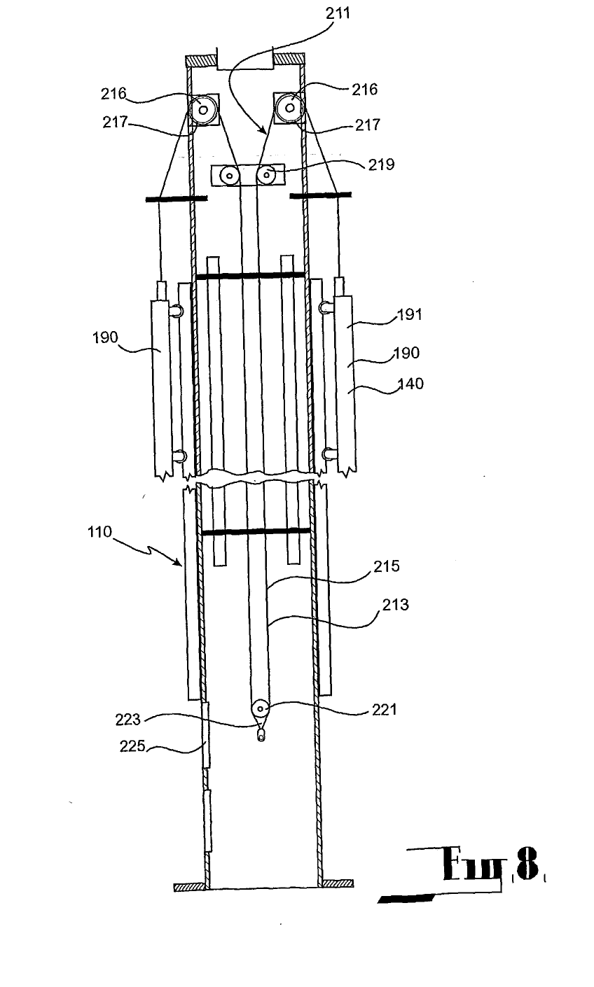

The carriage 194 includes a plurality of rollers 197. The rollers 197 are configured to engage against and travel along the tracks. In this embodiment, each roller incorporates a V profile 198 in its rolling face to correspond with the profile presented by the angular metal section, as seen in FIG. 7 of the drawings. The rollers 197 are arranged in two sets, with each set being positioned on opposed sides of the pole structure 111. Each set of rollers is mounted on a carrier 199 attached to a respective one of the frames 191.

A retaining means 203 is provided for releasably retaining the display means 140 in the operative position. In this embodiment, the retaining means 203 comprises a pair of locking lugs 205 provided on the pole structure 111, and a locking member 207 corresponding to each locking lug. Each locking member 207 comprises a cross-member 209 extending between the frames 191. Each locking lug 205 and its corresponding locking member 207 are provided with locking holes 211 which align when the display means 140 is in the operative condition to receive a locking element (not shown) such as a bolt.

A winching system 211 is provided for moving the display means 140 between the operative and lowered conditions. In this embodiment, the winching system 211 comprises a cable and pulley system 213, which includes a cable 215. The cable 215 has its ends connected to each display structure 190. From each display structure 190, the respective end section of the cable 215 passes over an upper pulley 216 forming part of the cable and pulley system. Each upper pulley 216 is mounted within the interior of the pole structure 111 and the cable 215 extends through an adjacent aperture 217 in the side of the pole structure 111 for access to the pulley. After passing over each upper pulley 216, the cable 215 passes over an adjacent guide pulley 219 also accommodated within the interior of the pole structure 111. The intermediate section of the cable 215 passes around a lower pulley 221 which incorporates a block 223 to which a winch (not shown) can be attached. The interior of the pole structure 111 is accessible for the purposes of attaching the winch to the block through an access door 225. With a winch (not shown) attached to the block 223, the display structures 190 can be moved from the operative position to the lowered position, after of course releasing the retaining means 203. Once operations on the display structures 190 have been performed at ground level, the winch can be again operated so as to move the display structures 190 from the lowered position to the operative position at which the retaining means 203 can be engaged so as to retain the display structures 190 as such position. The winch can then be removed. It will, of course, be appreciated that it is also possible to install a dedicated winch permanently within the pole structure 111 if desired. The present embodiment does not use a dedicated winch but rather utilises a winch which is installed only as required. In this way, a single winch can be used to service a multitude of pole structures.

In this embodiment, electrical, telecommunications and other paths to the display means 140 are established by plug-in connectors which are manually connected when the display means is in the operative position and manually disconnected when it is desired to move the display means 140 from the operative position to the lowered position. It will, of course, be appreciated that other arrangements are possible, including arrangements which establish the paths automatically (without the need for operator intervention) when the display means 140 assumes the operative position, and disconnects such paths when the display means 140 moves out of the operative condition.

A particular advantage of signage systems according to the embodiments is that the pole structure can be utilised for supporting various devices apart from signs. Because the pole structure can be utilised to support street lighting and street signs, the signage systems can be installed in prime locations where they provide optimal visibility to passing traffic. Normally, signage is excluded from such locations because of the need to dedicate those locations to street signs, street poles, traffic signals and the like.

From the foregoing, it is evident that the present invention provides a simple yet highly effective form of signage system which has significant flexibility to accommodate the requirements of various display sites and which allow signs on display to be readily changed when desired. Additionally, the configuration of the support structure and any devices supported thereon (such a street signs and street lighting assemblies) can be readily changed as desired.

It should be appreciated that the scope of the invention is not limited to the scope of the various embodiments described.

Throughout the specification, unless the context requires otherwise, the word “comprise” or variations such as “comprises” or “comprising”, will be understood to imply the inclusion of a stated integer or group of integers but not the exclusion of any other integer or group of integers.

The claims defining the invention are as follows:

1. A signage system for displaying a visual image, the signage system comprising a support structure for installation at a display site, the support structure being adapted to support display means for presenting the visual image, and mounting means for mounting the display means onto the support structure, wherein the visual image displayed by the display means is selectively changeable.

2. A signage system according to claim 1, wherein the support structure comprises a pole structure.

3. A signage system according to claim 2, wherein the pole structure is adapted to be removably accommodated in a receiving structure embedded in the ground at the display site.

4. A signage system according to claim 2 or 3 wherein the pole structure is formed in at least two pole sections comprising a lower section and an upper section.

5. A signage system according to claim 4, wherein the upper pole section is removable from the lower pole section.

6. A signage system according to claim 4 or 5, wherein the lower pole section is adapted to be received in the receiving structure.

7. A signage system according to claim 4, 5 or 6, wherein the display means comprises a first portion attached to the pole structure and a second portion adapted to be detachably connected to the first portion, the second portion being adapted to present the visual image.

8. A signage system according to claim 7, wherein the second portion of the display means is adapted to be mounted onto a track system provided on the pole structure, whereby the second portion is moveable along the track system for movement into and out of engagement with the first portion.

9. A signage system according to any one of claims 1 to 5, wherein the display means comprises a display unit selectively movable along the pole structure between operative and lowered positions, and a retaining means for releasably retaining the display unit in the operative position.

10. A signage system according to claim 9, wherein the pole structure is provided with a track system along which the display unit can travel when moving between the operative and lowered positions.

11. A signage system according to claim 8, further comprising a winch system for selectively moving the second portion of the display means along the pole structure.

12. A signage system according to claim 10, further comprising a winch system for selectively moving the display unit along the pole structure.

13. A signage system according to claim 8 or 10, wherein the winch system has at least a portion thereof accommodated within the interior of the pole structure.

14. A signage system according to claim 12, wherein the winch system comprises a cable and pulley mechanism, with a length of the cable accommodated in the interior of the pole structure.

15. A signage system according to any one of the preceding claims, wherein the display means is preferably mounted on the lower pole section.

16. A signage system according to any one of the preceding claims, wherein the support structure is adapted to support various devices in addition to said display means, said devices being selected from a group comprising: lighting apparatus for illuminating a surrounding area; surveillance apparatus; communications apparatus; monitoring apparatus; signalling apparatus; and signage.

17. A signage system comprising a pole structure and a plurality of devices supported on the pole structure, said devices being selected from a group comprising: signage; lighting apparatus; surveillance apparatus; communications apparatus; monitoring apparatus; and signalling apparatus.

18. A signage system according to claim 17, wherein the devices supported on the pole structure are selected according to the particular application of the signage system.

19. A signage system substantially as herein described with reference to the accompanying drawings.
